(19) United States
(12) Patent Application Publication
(10) Pub. No.: US 2013/0224434 A1
(43) Pub. Date: Aug. 29, 2013

(54) RESIN FOAM SHEET AND RESIN FOAM MEMBER

(71) Applicant: NITTO DENKO CORPORATION, (US)

(72) Inventors: Itsuhiro HATANAKA, Osaka (JP); Makoto SAITOU, Osaka (JP); Kazumichi KATO, Osaka (JP)

(73) Assignee: NITTO DENKO CORPORATION, Osaka (JP)

(21) Appl. No.: 13/777,606

(22) Filed: Feb. 26, 2013

(30) Foreign Application Priority Data
Feb. 28, 2012 (JP) 2012-041140
Dec. 7, 2012 (JP) 2012-268782

(51) Int. Cl. C08L 23/12

(52) U.S. Cl. CPC C08L 23/12
USPC 428/138; 428/131

(57) ABSTRACT

Disclosed is a resin foam sheet which has a low apparent density, is thin and flexible, and can be wound satisfactorily stably. The resin foam sheet has an apparent density of 0.02 to 0.30 g/cm³, a tensile strength of 0.5 to 3.0 MPa, a thickness of 0.20 to 0.70 mm, a length of 5 m or more, and a width of 300 mm or more and has openings on both sides. The resin foam sheet preferably has a value of 30% or less determined according to following Expression (1):

(Thickness tolerance)/(Median thickness)×100 (1)

### TECHNICAL FIELD

The present invention relates to a resin foam sheet and a resin foam member including the resin foam sheet.

### BACKGROUND ART

Resin foams are used typically as cushioning materials, heat insulating materials, and packaging materials upon transportation; building materials; as well as sealants and cushioning materials in electronic appliances. With decreasing sizes of electronic appliances and with increasing sizes of their screens, resin foams for use as sealants and cushioning materials in such electronic appliances have smaller and smaller areas and should have such flexibility as to exhibit sufficient sealability and shock-absorbing properties even having small areas. The resin foams should also have smaller thicknesses because the electronic appliances have smaller and smaller thicknesses.

Exemplary thin resin foams include a foam sheet obtained by compressing or stretching during or after foaming or by coating after foaming (see, for example, Japanese Unexamined Patent Application Publication (JP-A) No. 2009-190195, JP-A No. 2009-221237, and JP-A No. 2010-1407); a polyolefinic resin foam laminated sheet including a polyolefinic resin foam sheet and, laminated on one side thereof, a resin film (see JP-A No. 2003-94378); and an open-cell foam sheet which is obtained by subjecting an open-cell foam to a fabrication of cutting or machining and which is in the form of a sheet having open cells exposed from (opened in) both sides (front and back sides) (see JP-A No. 2010-100826).

The foam sheet, however, has surface skin layers having been lowly expanded and is disadvantageously inferior in bump conformability, flexibility, and shock absorption.

The polyolefinic resin foam laminated sheet includes a non-foamed support layer as a component thereof and disadvantageously has poor flexibility.

### CITATION LIST

### Patent Literature

PTL 1: JP-A No. 2009-190195
PTL 2: JP-A No. 2009-221237
PTL 3: JP-A No. 2010-1407
PTL 4: JP-A No. 2003-94378
PTL 5: JP-A No. 2010-100826

### SUMMARY OF INVENTION

### Technical Problem

Resin foams are often continuously wound into rolls such as “continuous rolls” or “long roll.” For this reason, resin foams are preferably capable of being stably wound without troubles such as wrinkling, breaking, stretching, and contraction upon winding.

Removal of the skin layers from the foam sheet by slicing has been proposed to solve the disadvantages of inferior bump conformability, flexibility, and shock absorption. Upon slicing of the foam sheet, a sliced foam sheet (foam sheet slice) should be hauled and wound under a tension lengthwise with a decreasing thickness of the foam sheet to be sliced. This is because the sliced foam sheet is attracted toward the original foam sheet with electrostatic action. However, the tension upon haul-off (winding) disadvantageously causes breaking, stretching, and widthwise contraction of the foam sheet, which in turn disadvantageously cause the sliced foam sheet to have an insufficient thickness accuracy. When the sliced foam sheet is to be wound simultaneously with the removal the skin layers by slicing, the winding tension disadvantageously causes breaking, stretching, and widthwise contraction of the foam sheet and impede stable winding of the foam sheet.

The polyolefinic resin foam laminated sheet, when wound into a roll and stored, often disadvantageously suffers from collapse of the roll core because of having the non-foamed support layer as a part thereof and thereby having a heavy weight.

The open-cell foam sheet has an open-cell structure with through holes which linearly penetrate the sheet (from one side to the other) so as to exhibit satisfactory water permeability and water absorbability. In addition, the open-cell foam sheet includes large openings in its surface and inside. The open-cell foam sheet therefore has a small tensile strength, disadvantageously suffers from breaking upon continuous slicing, and suffers from breaking due to the winding tension upon continuous winding.

Accordingly, an object of the present invention is to provide a resin foam sheet which has a low apparent density, is thin and flexible, and can be satisfactorily stably wound (can be satisfactorily stably wound).

Recent touch-screen smartphones and other electronic appliances include laminates of multiple members and should have not only a small thickness but also a small thickness tolerance of each member. To meet these requirements, resin foams to be used in the appliances require a high thickness accuracy. A resin foam having a poor thickness accuracy can cause disadvantages such as cabinet deformation and display unevenness when assembled into such an electronic appliance.

Accordingly, another object of the present invention is to provide a resin foam sheet which has a low apparent density, is thin and flexible, can be satisfactorily stably wound, and has a superior thickness accuracy.

### Solution to Problem

After intensive investigations to achieve the objects, the present inventors have found that a resin foam sheet, when having a high tensile strength, can be satisfactorily stably wound even when having a low apparent density and having a small thickness. In addition, the present inventors have found that such a high tensile strength facilitates continuous slicing of the surface and readily gives a resin foam sheet which has a superior thickness accuracy in addition to the above properties. The present invention has been made based on these findings.

Specifically, the present invention provides a resin foam sheet which has an apparent density of 0.02 to 0.30 g/cm³, a tensile strength of 0.5 to 3.0 MPa, a thickness of 0.20 to 0.70 mm, a length of 5 m or more, and a width of 300 mm or more and has openings on both sides thereof.

The resin foam sheet preferably has a value of 30% or less, in which the value is determined according to following Expression (1):

(Thickness tolerance)/(Median thickness)×100 (1)

wherein the thickness tolerance is determined by measuring thicknesses at intervals of 10 mm on a measurement line passing through lengthwise one point and extending widthwise from one end to the other, further measuring thicknesses at intervals of 10 mm on another measurement line passing through another point 1 m lengthwise away from the lengthwise one point and extending widthwise from one end to the other, and defining a difference between a maximum and a minimum among all the measured thicknesses as the thickness tolerance; and

the median thickness is defined as a value in the center of all the measured thicknesses arranged in increasing order.

The openings preferably have been formed by slicing.

The resin foam sheet preferably has been formed by foaming (expanding) a resin composition and particularly preferably has been formed by foaming a resin composition with a supercritical fluid.

In addition and advantageously, the present invention provides a resin foam member which includes the resin foam sheet; and a pressure-sensitive adhesive layer present on at least one side of the resin foam sheet.

### Advantageous Effects of Invention

The resin foam sheet according to an embodiment of the present invention has the above configuration, thereby has a low apparent density, is thin and flexible, and can be satisfactorily stably wound.

These and other objects, features, and advantages of the present invention will be more fully understood from the following description of embodiments with reference to the attached drawings. All numbers are herein assumed to be modified by the term “about.”

### BRIEF DESCRIPTION OF DRAWINGS

FIG. 1 depicts a schematic diagram of a continuous slicing system;

FIG. 2 depicts an electron photomicrograph of the top face of a long resin foam sheet according to Example 1; and

FIG. 3 depicts an electron photomicrograph of a cross-section of the long resin foam sheet according to Example 1.

### DESCRIPTION OF EMBODIMENTS

[Resin Foam Sheet]

A resin foam sheet according to an embodiment of the present invention is a sheet-form resin foam. The resin foam sheet according to the present invention may have been wound and be present as a roll (wound roll). As used herein such “resin foam sheet having an apparent density of 0.02 to 0.30 g/cm³, a tensile strength of 0.5 to 3.0 MPa, a thickness of 0.20 to 0.70 mm, a length of 5 m or more, and a width of 300 mm or more and having openings on both sides thereof” is also referred to as a “long resin foam sheet according to the present invention.”

The long resin foam sheet according to the present invention is preferably, but not limitatively, formed by subjecting a resin composition containing a resin to expansion molding. For high availability of openings, the long resin foam sheet is particularly preferably formed by subjecting the resin composition to expansion molding and slicing the surfaces of the resulting foam.

The long resin foam sheet according to the present invention has a cell structure (cellular structure). Though not limited, the cell structure is preferably a closed-cell structure or a semi-open/semi-closed cell structure (a cell structure as a mixture of a closed-cell structure and an open-cell structure in any arbitrary ratio) and is more preferably a semi-open/semi-closed cell structure from the viewpoint of strength. Though not critical, the long resin foam sheet according to the present invention has a percentage of the closed-cell structure of preferably 40% or less, and more preferably 30% or less, based on the total volume (100%) of the long resin foam sheet, for satisfactory flexibility. The cell structure can be controlled typically by regulating the expansion ratio by the amount or pressure of a blowing agent with which the resin composition is impregnated upon expansion molding.

Though not critical, the long resin foam sheet according to the present invention has an average cell diameter (average cell diameter) in the cell structure of typically preferably 10 to 200 μm, more preferably 10 to 190 μm, and furthermore preferably 20 to 150 μm. The long resin foam sheet, when having an average cell diameter of 10 μm or more, may advantageously readily have satisfactory shock absorption (cushioning properties). In addition, the long resin foam sheet less suffers from an excessively high cutting resistance, thereby less causes chipping of a cutting tool to be used upon cutting, and can advantageously be sliced with good workability. The long resin foam sheet, when having an average cell diameter of 200 μm or less, can advantageously be a foam having a fine cell structure, may be more easily applicable to a fine clearance, and may provide good dust-proofness more easily. This configuration may also advantageously suppress the formation of pinholes (through holes) that cause tearing and failure upon slicing. The resulting long resin foam sheet can maintain dust-proofness in a cross-sectional direction when processed to a small width (e.g., a small width such as a width of 0.5 mm).

The long resin foam sheet according to the present invention has openings on both sides. Specifically, the long resin foam sheet has opened cell structures (structures in which cells (pores) are opened or exposed from surface) on both sides. The long resin foam sheet exhibits high flexibility because it has openings on both sides, from which internal air readily escapes upon compression. The long resin foam sheet has an irregular cell structure, and a substance to pass through the resin foam sheet in a thickness direction passes through the long resin foam sheet not linearly but in an irregular complicated route. For this reason, if a solid substance (e.g., a particle) is to pass through the sheet in a thickness direction, the long resin foam sheet readily traps the solid substance in midway of the route. The long resin foam sheet therefore exhibits good dust-proofness even though having openings on both sides.

Though not limited, the long resin foam sheet according to the present invention may have openings on both sides partially or entirely.

The surface openings are preferably, but not limitatively, formed by surface slicing. The long resin foam sheet according to the present invention is more preferably formed by subjecting a resin composition to expansion molding to form a cell structure and slicing the surfaces of the resulting foam.

The long resin foam sheet according to the present invention has an apparent density (density) of 0.020 to 0.30 g/cm³, preferably 0.025 to 0.25 g/cm³, and more preferably 0.030 to 0.20 g/cm³. The long resin foam sheet, as having an apparent density of 0.020 g/cm³ or more, advantageously ensures sufficient strengths. The long resin foam sheet can advantageously be wound with a low winding tension while suppressing attraction typically with the electrostatic action that is liable to occur upon winding. The long resin foam sheet, as having an apparent density of 0.30 g/cm³ or less, can advantageously have good flexibility. In addition, the long resin foam sheet less suffers from an excessively high cutting resistance, thereby less causes cutting failures such as chipping of a cutting tool used upon cutting, and can advantageously be sliced with good workability.

The long resin foam sheet according to the present invention has a tensile strength of 0.50 to 3.0 MPa, more preferably 0.55 to 2.5 MPa, and furthermore preferably 0.60 to 2.0 MPa. The long resin foam sheet, as having a tensile strength of 0.50 MPa or more, is satisfactorily strong and advantageously less suffers from breaking and tearing, as well as stretching and widthwise contraction even when receiving force lengthwise upon preparation and usage of the resin foam sheet. In addition, the long resin foam sheet can advantageously be wound satisfactorily stably. The long resin foam sheet, as having a tensile strength of 3.0 MPa or less, less suffers from a high resistance upon cutting and is advantageous in working (e.g., slicing).

As used herein the term “tensile strength” refers to a tensile strength lengthwise of the resin foam sheet according to the present invention and is determined according to Japanese Industrial Standard (JIS) K 6767.

The long resin foam sheet according to the present invention has a thickness of 0.20 to 0.70 mm, and preferably 0.25 to 0.60 mm. The long resin foam sheet, as having a thickness of 0.20 mm or more, can advantageously have necessary strengths. The long resin foam sheet, as having a thickness of 0.70 mm or less, advantageously less causes repulsion upon compression even when the sheet is applied to a small gap or clearance.

The thickness is determined by measuring thicknesses of the resin foam sheet at intervals of 10 mm on a measurement line passing through lengthwise one point and extending widthwise from one end to the other, further measuring thicknesses at intervals of 10 mm on another measurement line passing through another point 1 m lengthwise away from the lengthwise one point and extending widthwise from one end to the other, and defining an average of all the measured thicknesses as the thickness of the resin foam sheet.

The long resin foam sheet according to the present invention has a length of 5 m or more (e.g., 5 to 1000 m), preferably 30 m or more (e.g., 30 to 500 m), and more preferably 50 m or more (e.g., 50 to 300 m).

The long resin foam sheet according to the present invention has a width of 300 mm or more (e.g., 300 to 1500 mm), and preferably 400 mm or more (e.g., 400 to 1200 mm). The long resin foam sheet, as having a width of 300 mm or more, allows designing and working with high degrees of freedom.

Though not critical, the long resin foam sheet according to the present invention has a compression stress of preferably 5.0 N/cm² or less, more preferably 4.5 N/cm² or less, and furthermore preferably 4.0 N/cm² or less when compressed by 50% (upon 50%-compression). The long resin foam sheet, when having a compression stress of 5.0 N/cm² or less upon 50%-compression, may advantageously have better flexibility and have lower repulsive force upon compression.

The compression stress upon 50%-compression may be determined according to JIS K 6767 by measuring a stress (N) upon compression of the resin foam sheet in a thickness direction by 50% of the initial thickness, and converting the stress into a value per unit area (cm²).

Though not critical, the long resin foam sheet according to the present invention has a value determined according to following Expression (1) of preferably 30% or less, more preferably 25% or less, and furthermore preferably 23% or less:

(Thickness tolerance)/(Median thickness)×100 (1)

wherein the thickness tolerance is determined by measuring thicknesses at intervals of 10 mm on a measurement line passing through lengthwise one point and extending widthwise from one end to the other, further measuring thicknesses at intervals of 10 mm on another measurement line passing through another point 1 m lengthwise away from the lengthwise one point and extending widthwise from one end to the other, and defining a difference between a maximum and a minimum among all the measured thicknesses as the thickness tolerance; and the median thickness is defined as a value in the center of all the measured thicknesses arranged in increasing order.

The long resin foam sheet, when having a “value determined according to Expression (1)” of 30% or less, may less suffer from wrinkling upon winding, particularly wrinkling upon winding at high speed and advantageously exhibit better winding stability. In addition, the long resin foam sheet may advantageously exhibit a high thickness accuracy. Typically, such resin foam sheet having a high thickness accuracy, when assembled into an electronic appliance, can effectively less cause disadvantages such as cabinet deformation and display unevenness. As used herein the term “high speed” upon winding refers typically to a speed of 10 to 40 meters per minute.

The long resin foam sheet according to the present invention may be formed through the step of subjecting a resin composition to expansion molding, as mentioned above. The resin composition preferably, but not limitatively, includes a polyolefinic resin as a resin component.

Specifically, the long resin foam sheet is preferably formed through the step of subjecting a resin composition containing a polyolefinic resin to expansion molding. The long resin foam sheet is therefore preferably a long polyolefinic resin foam sheet. Such a resin composition containing a polyolefinic resin is herein also referred to as a “polyolefinic resin composition.”

The resin composition may further contain any of other components and additives in addition to the resin. Each of respective components, such as the resins, the other components, and the additives, may be used alone or in combination. Though not critical, the resin composition has a resin content of preferably 40 percent by weight or more, more preferably 50 percent by weight or more, and furthermore preferably 60 percent by weight or more, based on the total amount (100 percent by weight) of the resin composition.

As the polyolefinic resin, the polyolefinic resin composition preferably, but not limitatively, contains a polymer including (formed from) an α-olefin as an essential monomer component, namely, a polymer having at least constitutional units derived from an α-olefin in the molecule (per molecule). The polyolefinic resin may be a polymer including one or more α-olefins alone or a polymer including one or more α-olefins in combination with one or more monomer components other than α-olefins.

The polyolefinic resin may be a homopolymer (monopolymer), or a copolymer (interpolymer) including two or more different monomers. The polyolefinic resin, when being a copolymer, may be a random copolymer or a block copolymer. The polyolefinic resin may include a single polymer, or two or more different polymers in combination.

The polyolefinic resin preferably, but not limitatively, includes a linear polyolefin so as to give a polyolefinic resin foam having a high expansion ratio.

The α-olefins are typified by α-olefins having 2 to 8 carbon atoms, such as ethylene, propylene, butene-1, pentene-1, hexene-1,4-methyl-pentene-1, heptene-1, and octene-1. Each of different α-olefins may be used alone or in combination.

The monomer components other than α-olefins are typified by ethylenically unsaturated monomers such as vinyl acetate, acrylic acid, acrylic esters, methacrylic acid, methacrylic esters, and vinyl alcohol. Each of different monomer components other than α-olefins may be used alone or in combination.

The polyolefinic resin is typified by low-density polyethylenes, medium-density polyethylenes, high-density polyethylenes, linear low-density polyethylenes, polypropylenes (propylene homopolymers), copolymers of ethylene and propylene, copolymers of ethylene and another α-olefin than ethylene, copolymers of propylene and another α-olefin than propylene, copolymers of ethylene, propylene, and another α-olefin than ethylene and propylene, and copolymers of propylene and an ethylenically unsaturated monomer.

For satisfactory thermal stability, the polyolefinic resin preferably includes a polymer including propylene as an essential monomer component (polypropylene polymer), namely, a polymer having at least constitutional units derived from propylene. Specifically, preferred examples of the polyolefinic resin are polypropylene polymers such as polypropylenes (propylene homopolymers), copolymers of ethylene and propylene, and copolymers of propylene and another α-olefin than propylene. Each of different α-olefins than propylene may be used alone or in combination.

Though not critical, the polyolefinic resin has a content of the α-olefin(s) of typically preferably 0.1 to 10 percent by weight, and more preferably 1 to 5 percent by weight, based on the total amount (100 percent by weight) of monomer components constituting the polyolefinic resin.

The polyolefinic resin composition may further include a “rubber and/or thermoplastic elastomer” as another component in addition to the polyolefinic resin.

The rubber is typified by, but not limited to, natural or synthetic rubbers such as natural rubbers, polyisobutylenes, isoprene rubbers, chloroprene rubbers, butyl rubbers (isobutylene-isoprene rubbers), and nitrile-butyl rubbers (acrylonitrile-butadiene rubbers). Each of different rubbers may be used alone or in combination.

The thermoplastic elastomer is typified by, but not limited to, thermoplastic olefinic elastomers such as ethylene-propylene copolymers, ethylene-propylene-diene copolymers, ethylene-vinyl acetate copolymers, polybutenes, polyisobutylenes, and chlorinated polyethylenes; thermoplastic styrenic elastomers such as styrene-butadiene-styrene copolymers, styrene-isoprene-styrene copolymers, styrene-isoprene-butadiene-styrene copolymers, and polymers of hydrogenated derivatives of them; thermoplastic polyester elastomers; thermoplastic polyurethane elastomers; and thermoplastic acrylic elastomers. Each of different thermoplastic elastomers may be used alone or in combination.

Though not critical, the polyolefinic resin composition has a content of the “rubber and/or thermoplastic elastomer” of preferably 0 to 75 percent by weight, more preferably 10 to 70 percent by weight, and furthermore preferably 15 to 60 percent by weight, based on the total amount (100 percent by weight) of the polyolefinic resin composition.

The polyolefinic resin composition may further include, in addition to the polyolefinic resin, a “mixture (composition) containing a softener and at least one of a rubber and a thermoplastic elastomer” as another component. The “mixture (composition) containing a softener and at least one of a rubber and a thermoplastic elastomer” may further include one or more additives according to necessity. The “additives” herein do not include softeners. The “mixture containing a softener and at least one of a rubber and a thermoplastic elastomer” is typified by a mixture including only a rubber, a thermoplastic elastomer, and a softener; a mixture including only a rubber and a softener; or a mixture including only a thermoplastic elastomer and a softener. The “mixture containing a softener and at least one of a rubber and a thermoplastic elastomer” is further typified by a mixture including a rubber, a thermoplastic elastomer, and a softener; a mixture (composition) including a rubber and a softener; and a mixture including a thermoplastic elastomer and a softener. The “mixture containing a softener and at least one of a rubber and a thermoplastic elastomer” is preferably exemplified by a mixture containing a rubber and/or thermoplastic elastomer, a softener, and an additive (e.g., after-mentioned additives such as carbon black).

The rubber and the thermoplastic elastomer in the “mixture containing a softener and at least one of a rubber and a thermoplastic elastomer” are not limited, as long as allowing the resin composition to foam or expand, and are typified by known or customary rubbers and thermoplastic elastomers.

The rubber in the “mixture containing a softener and at least one of a rubber and a thermoplastic elastomer” is preferably typified by, but not limited to, the rubbers exemplified as the rubber in the “rubber and/or thermoplastic elastomer.” Each of different rubbers may be used alone or in combination.

The thermoplastic elastomer in the “mixture containing a softener and at least one of a rubber and a thermoplastic elastomer” is preferably typified by, but not limited to, the thermoplastic elastomers exemplified as the thermoplastic elastomer in the “rubber and/or thermoplastic elastomer.” Each of different thermoplastic elastomers may be used alone or in combination.

The “rubber and/or thermoplastic elastomer” in the “mixture containing a softener and at least one of a rubber and a thermoplastic elastomer” is preferably an olefinic elastomer and is particularly preferably an olefinic elastomer having a structure including a polyolefinic component and an olefinic rubber component which are microphase-separated from each other. The olefinic elastomer having a structure including a polyolefinic component and an olefinic rubber component microphase-separated from each other is preferably typified by elastomers each including a polypropylene resin (PP) and an ethylene-propylene rubber (EPM) or ethylene-propylene-diene rubber (EPDM). From the viewpoint of compatibility (miscibility), the olefinic elastomer includes the polyolefinic component and the olefinic rubber component in a mass ratio of the former to the latter of preferably 90:10 to 10:90, and more preferably 80:20 to 20:80.

The softener (flexibilizer) is preferably typified by, but not limited to, softeners generally used in rubber products. The softener, when contained, contributes to better workability and flexibility. Each of different softeners may be used alone or in combination.

Specifically, the softener is exemplified by petroleum substances such as process oils, lubricating oils, paraffin, liquid paraffin, petroleum asphalt, and petrolatum; coal tars such as coal tar and coal-tar pitch; fatty oils such as caster oil, linseed oil, rapeseed oil, soybean oil, and coconut oil; waxes such as tall oil, beeswax, carnauba wax, and lanolin; synthetic polymeric substances such as petroleum resins, coumarone-indene resins, and atactic polypropylenes; ester compounds such as dioctyl phthalate, dioctyl adipate, and dioctyl sebacate; as well as microcrystalline wax, factice (vulcanized oil), liquid polybutadienes, modified liquid polybutadienes, liquid Thiokol®, liquid polyisoprenes, liquid polybutenes, and liquid ethylene-α-olefin copolymers. Among them, paraffinic, naphthenic, and aromatic mineral oils, liquid polyisoprenes, liquid polybutenes, liquid ethylene-α-olefin copolymers are preferred, of which liquid polyisoprenes, liquid polybutenes, and liquid ethylene-α-olefin copolymers are more preferred.

Though not limited, the “mixture containing a softener and at least one of a rubber and a thermoplastic elastomer” may contain the softener in a content of preferably 1 to 200 parts by mass, more preferably 5 to 100 parts by mass, and furthermore preferably 10 to 50 parts by mass, per 100 parts by mass of the polyolefin component. The softener, if contained in an excessively high content, may be dispersed insufficiently upon kneading with the rubber and/or thermoplastic elastomer.

The additive(s) for use in the “mixture containing a softener and at least one of a rubber and a thermoplastic elastomer” is typified by, but not limited to, age inhibitors, antiweathering agents, ultraviolet absorbers, dispersing agents, plasticizers, carbon black, antistatic agents, surfactants, tension modifiers, and flowability improvers. Each of different additives may be used alone or in combination.

The “mixture containing a softener and at least one of a rubber and a thermoplastic elastomer” may contain the additive(s) in a content of preferably, but not limitatively, 0.01 to 100 parts by mass, more preferably 0.05 to 50 parts by mass, and furthermore preferably 0.1 to 30 parts by mass, per 100 parts by mass of the polyolefin component. The additive(s), when contained in a content of 0.01 part by mass or more, may advantageously readily exhibit its effects.

Though not critical, the “mixture containing a softener and at least one of a rubber and a thermoplastic elastomer” has a MFR (230° C.) (melt flow rate at 230° C.) of preferably 3 to 10 g/10 min, and more preferably 4 to 9 g/10 min, for satisfactory formability of the polyolefinic resin composition.

The “mixture containing a softener and at least one of a rubber and a thermoplastic elastomer” has a JIS-A hardness of preferably, but not limitatively, 30° to 90°, and more preferably 40° to 85°. The mixture, when having a JIS-A hardness of 30° or more, may advantageously give a cell structure with a high expansion ratio. The mixture, when having a JIS-A hardness of 90° or less, may advantageously give a flexible foam. As used herein the term “JIS-A hardness” refers to a hardness measured according to ISO 7619 (JIS K 6253).

The polyolefinic resin composition may further contain one or more additives within ranges not adversely affecting advantageous effects of the present invention. The additives are typified by foam-nucleating agents, crystal-nucleating agents, plasticizers, lubricants, colorants (e.g., pigments and dyestuffs), ultraviolet absorbers, antioxidants, age inhibitors, fillers, reinforcers, antistatic agents, surfactants, tension modifiers, shrinkage inhibitors, flowability improvers, clay, vulcanizers, coupling agents (surface preparation agents), and flame retardants. Each of different additives may be used alone or in combination.

The foam-nucleating agent, when contained in the resin composition, contributes to the formation of a resin foam having a uniform and fine cell structure. For this reason, the polyolefinic resin composition preferably contains a foam-nucleating agent.

Examples of the foam-nucleating agents include particles, which are typified by talc, silica, alumina, zeolite, calcium carbonate, magnesium carbonate, barium sulfate, zinc oxide, titanium oxide, aluminum hydroxide, magnesium hydroxide, mica, montmorillonite and other clays, carbon particles, glass fibers, and carbon tubes. Each of different particles may be used alone or in combination.

The polyolefinic resin composition may contain the foam-nucleating agent(s) in a content of preferably, but not limitatively, 0.5 to 150 parts by weight, more preferably 0.5 to 125 parts by weight, and furthermore preferably 1 to 120 parts by weight, per 100 parts by weight of the resin(s) in the composition.

Though not critical, the particles have an average particle diameter (particle size) of preferably 0.1 to 20 μm.

Particles having an average particle diameter of less than 0.1 μm may fail to function as a foam-nucleating agent. In contrast, particles having an average particle diameter of more than 20 μm may cause outgassing (gas escaping) upon expansion molding.

The flame retardant, when contained in the resin composition, contributes to the formation of a flame-retardant resin foam, and the resulting resin foam is usable in applications requiring flame retardancy, such as in electric or electronic appliances. For this reason, the polyolefinic resin composition may further contain a flame retardant.

The flame retardant may be in a powder form or in another form than powder. Such powdery flame retardant is preferably an inorganic flame retardant. The inorganic flame retardant is typified by bromine flame retardants, chlorine flame retardants, phosphorus flame retardants, antimony flame retardants, and non-halogen/non-antimony inorganic flame retardants. Among them, chlorine flame retardants and bromine flame retardants, upon combustion, evolve gaseous components that are harmful to the human body and corrosive to appliances; whereas phosphorus flame retardants and antimony flame retardants are disadvantageously harmful and explosive. To avoid these disadvantages, non-halogen/non-antimony inorganic flame retardants are preferred as inorganic flame retardants. The non-halogen/non-antimony inorganic flame retardants are typified by aluminum hydroxide, magnesium hydroxide, a hydrate of magnesium oxide and nickel oxide, a hydrate of magnesium oxide and zinc oxide, and other hydrated metallic compounds. Such hydrated metal oxides may have been subjected to a surface treatment. Each of different flame retardants may be used alone or in combination.

The flame retardants have flame retardancy. They preferably further function as a foam-nucleating agent so as to give a resin foam with a high expansion ratio. Such flame retardants also functioning as a foam-nucleating agent are typified by magnesium hydroxide and aluminum hydroxide.

The polyolefinic resin composition may contain the flame retardant(s) in a content of preferably, but not limitatively, 30 to 150 parts by weight, and more preferably 60 to 120 parts by weight, per 100 parts by weight of the resin(s) in the composition.

The lubricant, when contained in the resin composition, may contribute to better flowability of the resin composition and to less thermal degradation. For this reason, the polyolefinic resin composition may contain a lubricant.

The lubricants are typified by, but not limited to, hydrocarbon lubricants such as liquid paraffin, paraffin wax, microcrystalline wax, and polyethylene wax; fatty acid lubricants such as stearic acid, behenic acid, and 12-hydroxystearic acid; and ester lubricants such as butyl stearate, stearic monoglyceride, pentaerythritol tetrastearate, hydrogenated caster oil, and stearyl stearate. Each of different lubricants may be used alone or in combination.

The polyolefinic resin composition may contain the lubricant(s) in a content of preferably, but not limitatively, 0.1 to 10 parts by weight, and more preferably 0.5 to 5 parts by weight, per 100 parts by weight of the resin(s) in the composition.

Though not limited, the polyolefinic resin composition may be prepared by kneading resin components (e.g., the polyolefinic resin), optional other components, and optional additives. The polyolefinic resin composition may also be prepared by kneading and extruding with a known melting/kneading extruding machine such as single-screw kneader-extruder or twin-screw kneader-extruder.

The polyolefinic resin composition may be in any form not limited and may for example be in the form of strands; sheets; slabs (flat plates); and pellets prepared by cooling strands with water or air and cutting them to suitable lengths. Above all, the polyolefinic resin composition is preferably kneaded, pelletized, and used as pellets for satisfactory productivity.

The long resin foam sheet according to the present invention is preferably formed through the step of subjecting the resin composition (e.g., the polyolefinic resin composition) to expansion molding, as described above. A way to expand (foam) the resin composition is typified by, but not limited to, physical foaming processes and chemical foaming processes. In the physical foaming processes, the resin composition is impregnated with a low-boiling liquid (blowing agent) (i.e., the blowing agent is dispersed in the resin composition), and the blowing agent is then volatilized to form cells (bubbles). In the chemical foaming processes, a compound added to the resin composition is thermally decomposed to evolve a gas, and the gas forms cells. Among them, physical foaming processes are preferred, of which a physical foaming process using a high-pressure gas as the blowing agent is more preferred, so as to avoid contamination of the resin foam sheet and to give a fine and homogeneous cell structure. For these reasons, the long resin foam sheet according to the present invention is particularly preferably formed by impregnating the polyolefinic resin composition with a high-pressure gas (e.g., an after-mentioned inert gas), and expanding (foaming) the impregnated resin composition.

The blowing agent for use in the physical foaming processes is preferably, but not limitatively, a gas so as to give a fine cell structure with a high cell density. Among such gases, preferred are inert gases that are inert to resins constituting the resin foam sheet (resins contained in the resin composition, such as the polyolefinic resin and the “rubber and/or thermoplastic elastomer”).

Exemplary inert gases include, but are not limited to, carbon dioxide, nitrogen gas, air, helium, and argon. Of the inert gases, carbon dioxide is preferred because the resin composition can be impregnated with carbon dioxide in a large amount at a high speed. Each of different inert gases may be used alone or in combination.

The resin composition (e.g., the polyolefinic resin composition) may be impregnated with (incorporated with) the blowing agent in an amount of preferably, but not limitatively, 2 to 10 percent by weight based on the total weight (100 percent by weight) of the resin composition.

The inert gas is preferably in a supercritical state upon impregnation to speed up the impregnation (incorporation) to the resin composition. Specifically, the long resin foam sheet according to the present invention is preferably formed by foaming the resin composition (e.g., the polyolefinic resin composition) using a supercritical fluid. The inert gas, when being a supercritical fluid (in a supercritical state), has a higher solubility in the resin composition and can thereby be incorporated into the resin composition in a higher concentration. In addition, because of its high concentration, the supercritical inert gas generates a larger number of cell nuclei upon an abrupt pressure drop (decompression) after impregnation. These cell nuclei grow to give cells which are present in a higher density than that in a foam having the same porosity and prepared with the same gas but in another state. The use of the supercritical inert gas can therefore give fine cells. Carbon dioxide has a critical temperature and a critical pressure of 31° C. and 7.4 MPa, respectively.

Of the physical foaming processes using a gas as the blowing agent, preferred is a process of impregnating the resin composition with a high-pressure gas (e.g., an inert gas), and releasing (decompressing) pressure of the impregnated resin composition (typically to atmospheric pressure) to expand the resin composition. Specifically, exemplary processes include a process of forming the long resin foam sheet through the steps of molding the resin composition to give an unexpanded molded article, impregnating the unexpanded molded article with a high-pressure gas, and decompressing the impregnated molded article (typically to atmospheric pressure) to expand the molded article; and a process of forming the long resin foam sheet by melting the resin composition, impregnating the molten resin composition with a gas (e.g., an inert gas) under a pressure (under a load), decompressing the impregnated molten resin composition (typically to atmospheric pressure) to expand the resin composition, and molding the resin composition simultaneously with the expansion.

Specifically, the long resin foam sheet according to the present invention may be formed in a batch system or in a continuous system. In the batch system, the resin composition (e.g., the polyolefinic resin composition) is molded into a suitable form such as a sheet to give an unexpanded resin molded article (unexpanded molded article), the unexpanded resin molded article is impregnated with a high-pressure gas, and the impregnated resin molded article is expanded through decompression (pressure release). In the continuous system, the resin composition is kneaded with a high-pressure gas under a high pressure (under a heavy load), and the kneadate is molded and decompressed (pressure-released) simultaneously, thus molding and expansion (foaming) are performed simultaneously.

Exemplary processes to form an unexpanded resin molded article in the batch system include, but are not limited to, a process of molding the resin composition using an extruder such as single-screw extruder or twin-screw extruder; a process of uniformly kneading the resin composition in a kneading machine equipped with one or more blades typically of roller, cam, kneader, or Banbury type, and press-forming the kneadate typically using a hot-plate press; and a process of molding the resin composition using an injection molding machine. The unexpanded resin molded article may be in any form not limited, such as sheet form, roll form, or plate form. The batch system gives an unexpanded resin molded article having a desired shape and thickness by molding the resin composition according to a suitable procedure.

In the batch system, a cell structure is formed through a gas-impregnation step and a decompression step. In the gas impregnation step, the unexpanded resin molded article is placed in a pressure-tight vessel, into which a high-pressure gas is injected (introduced), and the unexpanded resin molded article is thereby impregnated with the gas. In the decompression step, the impregnated resin molded article is decompressed (usually to atmospheric pressure) at the time when the resin molded article is sufficiently impregnated with the gas, to form cell nuclei in the resin composition.

In the continuous system, the resin composition is expanded and molded through a kneading/impregnation step and a molding/decompression step. In the kneading/impregnation step, the resin composition is kneaded using an extruder (e.g., single-screw extruder or twin-screw extruder) or an injection molding machine while a high-pressure gas is injected (introduced or incorporated) thereinto to impregnate the resin composition sufficiently with the high-pressure gas. In the molding/decompression step, the resin composition is extruded typically through a die arranged at the tip of the extruder and is thereby decompressed (usually to atmospheric pressure), and the resin composition is thus molded and expanded simultaneously.

Where necessary, the batch system and the continuous system may further include the step of heating so as to grow cell nuclei. The growth of cell nuclei may also be performed at room temperature without providing the heating step. After the cell growth, the article may be abruptly cooled typically with cold water to fix its shape according to necessity. The high-pressure gas may be introduced continuously or discontinuously. Though not limited, the heating to grow the cell nuclei may be performed by a known or customary procedure such as heating with a water bath, oil bath, hot roll, hot-air oven, far-infrared rays, near-infrared rays, or microwaves.

The gas impregnation pressure in the gas-impregnation step of the batch system or in the kneading/impregnation step of the continuous system may be suitably selected in consideration typically of gas type and operability, but is typically preferably 5 MPa or more (e.g., 5 to 100 MPa), and more preferably 7 MPa or more (e.g., 7 to 100 MPa). Specifically, the resin composition is preferably impregnated with a gas at a pressure of 5 MPa or more (e.g., 5 to 100 MPa) and is more preferably impregnated with a gas at a pressure of 7 MPa or more (e.g., 7 to 100 MPa). If the gas pressure is less than 5 MPa, considerable cell growth may occur during expansion, and this may cause the cells to have excessively large diameters and may cause disadvantages such as insufficient dustproofing effects. The reasons for this are as follows. When impregnation is performed under a low pressure, the amount of the impregnated gas is relatively small and the cell nuclei grow at a lower rate as compared to impregnation under a high pressure. As a result, cell nuclei are formed in a smaller number. Because of this, the gas amount per each cell increases rather than decreases, resulting in excessively large cell diameters. Furthermore, under pressures lower than 5 MPa, merely a slight change in impregnation pressure results in considerable changes in cell diameter and cell density, and this may often impede the control of cell diameter and cell density.

The temperature upon gas impregnation (impregnation temperature) in the gas-impregnation step of the batch system or in the kneading/impregnation step of the continuous system may vary depending on types of the gas and resin to be used, can be selected within a wide range, but is preferably 10° C. to 350° C. in consideration typically of operability. More specifically, the impregnation temperature in the batch system is preferably 10° C. to 250° C., more preferably 40° C. to 240° C., and furthermore preferably 60° C. to 230° C. The impregnation temperature in the continuous system is preferably 60° C. to 350° C., more preferably 100° C. to 320° C., and furthermore preferably 150° C. to 300° C. When carbon dioxide is used as the high-pressure gas, the temperature upon impregnation (impregnation temperature) is preferably 32° C. or higher, and particularly preferably 40° C. or higher for keeping carbon dioxide to the supercritical state. The resin composition after being impregnated with the gas but before expansion molding may be cooled to a temperature suitable for expansion molding (e.g., 150° C. to 190° C.)

The decompression rate in the decompression step (pressure releasing step) of the batch system or the continuous system is preferably, but not limitatively, 5 to 300 MPa/second so as to give a cell structure including uniform and fine cells.

When a heating step is provided for the growth of cell nuclei, the heating may be performed at a temperature of typically preferably 40° C. to 250° C., and more preferably 60° C. to 250° C.

The cell structure, density, and relative density (expansion ratio) of the long resin foam sheet according to the present invention may be controlled by choosing the expansion process and expansion conditions (e.g., type and amount of the blowing agent; and temperature, pressure, time, and other conditions upon expansion) in expansion molding of the resin composition according to types of resins constituting the resin composition. The tensile strength of the long resin foam sheet may be controlled by regulating composition of resins constituting the resin composition, and cell structure and density of the resulting foam.

Specifically, in a preferred but not limitative embodiment, a polyolefinic resin composition is expanded with a supercritical fluid (particularly preferably supercritical carbon dioxide), which polyolefinic resin composition includes the polyolefinic resin and the “rubber and/or thermoplastic elastomer” and has a content of the “rubber and/or thermoplastic elastomer” of 10 to 70 percent by weight based on the total amount (100 percent by weight) of the composition.

As is described above, the long resin foam sheet according to the present invention is particularly preferably formed by subjecting a resin composition to expansion molding, and slicing the surfaces of the resulting article. Specifically, the long resin foam sheet is preferably formed by expanding the resin composition to give a foam (sheet foam A) and slicing the both surfaces of the foam. The sheet foam A (foam obtained by expansion of the resin composition) often has layer portions in the vicinity of its surfaces. The layer portions have densities higher than that of a core portion of the foam and are “skin layers” having low expansion ratios than that of the core portion. The slicing can remove the layer portions (skin layers) to expose the inner cell structure from the surfaces of the foam to thereby provide openings. The slicing also contributes to a higher thickness accuracy.

In an embodiment, a long resin foam sheet is prepared by expanding the resin composition to give a thick sheet foam A, and slicing the surfaces of the thick sheet foam A. The resulting long resin foam sheet can have a desired thickness, have openings on both sides thereof, and exhibit a high thickness accuracy while controlling the “value determined according to Expression (1).” The long resin foam sheet, as exhibiting a high thickness accuracy on surface, can be satisfactorily stably wound and can be assembled with less troubles.

The long resin foam sheet according to the present invention, as having an apparent density within the predetermined range and a thickness within the predetermined range, is thin and flexible. The long resin foam sheet also has a tensile strength within the predetermined range and thereby has satisfactory strengths even having openings on both sides thereof. In addition, the long resin foam sheet can be satisfactorily stably wound because it less suffers from troubles upon winding, such as breaking, widthwise contraction (semipermanent contraction caused by a lengthwise tension upon winding), and lengthwise stretching (semipermanent stretching caused by a lengthwise tension upon winding) even upon winding with a high tension. The long resin foam sheet can therefore have a wide and long form.

Though winding conditions are not limited, the winding may be performed with a winding tension of preferably 1 to 50 N, more preferably 1 to 45 N, and furthermore preferably 2 to 40 N when the long resin foam sheet according to the present invention has a width of 500 mm; and performed with a winding tension of preferably 2 to 100 N, more preferably 2 to 90 N, and furthermore preferably 4 to 80 N when the long resin foam sheet has a width of 1000 mm. Winding with an excessively high winding tension may often cause breaking upon winding and may adversely affect the winding stability. In contrast, winding with an excessively low winding tension may often cause misalignment (displacement) upon winding and may adversely affect the winding stability.

Such long resin foam sheets according to embodiments of the present invention are advantageously used typically as dust proofers, sealants (foamed sealants), acoustic insulators, and cushioning materials which are used for mounting or assembling a member or part to a predetermined position. The long resin foam sheets may be processed into various shapes according to the intended use.

[Resin Foam Member]

A resin foam member (resin foam composite) according to an embodiment of the present invention includes at least a long resin foam sheet according to the present invention. The resin foam member preferably has a structure including the long resin foam sheet laminated with another layer. The resin foam member is preferably, but not limitatively, in the form of a sheet (film) or roll. The resin foam member may be processed into a shape of every kind according to the intended use.

The other layer may be present on only one side or on both sides of the long resin foam sheet according to the present invention. The other layer is provided in a number of at least one. The other layer may be a single layer or a laminate of two or more layers.

The other layer is typified by pressure-sensitive adhesive layers, intermediate layers (e.g., an under coat for better adhesion), and base layers (e.g., film layer and nonwoven fabric layer).

Among them, pressure-sensitive adhesive layers are preferred as the other layer. Specifically, the resin foam member according to the present invention preferably includes the long resin foam sheet according to the present invention; and a pressure-sensitive adhesive layer on at least one side of the long resin foam sheet. The resin foam member, when having a pressure-sensitive adhesive layer, is advantageous for fixing or temporal fixing to an adherend and is advantageously satisfactorily assembled. The pressure-sensitive adhesive layer also allows the placement of a working mount on the resin foam sheet therethrough.

A pressure-sensitive adhesive constituting the pressure-sensitive adhesive layer is typified by, but not limited to, acrylic pressure-sensitive adhesives, rubber pressure-sensitive adhesives (e.g., natural rubber pressure-sensitive adhesives and synthetic rubber pressure-sensitive adhesives), silicone pressure-sensitive adhesives, polyester pressure-sensitive adhesives, urethane pressure-sensitive adhesives, polyamide pressure-sensitive adhesives, epoxy pressure-sensitive adhesives, vinyl alkyl ether pressure-sensitive adhesives, and fluorine-containing pressure-sensitive adhesives. Each of different pressure-sensitive adhesives may be used alone or in combination. The pressure-sensitive adhesive may be a pressure-sensitive adhesive of every form, such as an emulsion pressure-sensitive adhesive, solvent-borne pressure-sensitive adhesive, hot-melt pressure-sensitive adhesive, oligomer pressure-sensitive adhesive, or solid pressure-sensitive adhesive.

The pressure-sensitive adhesive layer has a thickness of preferably, but not limitatively, 2 to 100 μm, and more preferably 10 to 100 μm. The thinner the pressure-sensitive adhesive layer is, the more effectively the attachment of a contaminant or dust is prevented, thus being preferred. The pressure-sensitive adhesive layer may have a single-layer structure or a multilayer structure.

The pressure-sensitive adhesive layer may be arranged on at least one side of the long resin foam sheet according to the present invention by the medium of at least one lower layer. The lower layer is typified by pressure-sensitive adhesive layers other than the pressure-sensitive adhesive layer; intermediate layers; under coats; and base layers (substrate layers). Among them, base layers are preferred as the lower layer, of which film layers such as plastic film layers and nonwoven fabric layers are more preferred, for better breaking strength.

The long resin foam sheet and resin foam member according to the present invention are preferably, but not limitatively, used for assembling (mounting) a member or part of every kind to a predetermined position and are particularly advantageously used for assembling (mounting) a part constituting an electric or electronic appliance to a predetermined position in the electric or electronic appliance. Specifically, the resin foam sheet and resin foam member are preferably usable in electric or electronic appliances.

The member or part is preferably, but not limited to, a member or part in electric or electronic appliances. The member or part for electric or electronic appliances is typified by image display members (display units) (of which small-sized image display members are preferred) to be mounted to image display devices such as liquid crystal displays, electroluminescent displays, and plasma displays; cameras and lenses (of which small-sized cameras and lenses are preferred) to be mounted to mobile communication devices such as so-called “cellular phones” and “personal digital assistants”; and other optical members or optical parts.

More specifically, the long resin foam sheet or resin foam member according to the present invention is usable around a display unit typically of a liquid crystal display (LCD) or in between a display unit and a cabinet (frame) typically of an LCD.

The long resin foam sheet according to the present invention is thin and flexible and can have a higher thickness accuracy. Accordingly, the long resin foam sheet or resin foam member according to the present invention, even when used in an electric or electronic appliance including an assemblage of many parts or members, such as a smartphone bearing a touch-screen panel, less causes a high repulsive force and less causes display defects such as liquid crystal display unevenness in the display unit.

### EXAMPLES

The present invention will be illustrated in further detail with reference to several working examples below, which are by no means intended to limit the scope of the present invention.

### Example 1

In a twin-screw kneader (The Japan Steel Works, LTD. (JSW)) at a temperature of 200° C. were kneaded 45 parts by weight of a polypropylene [trade name “EA9,” Japan Polypropylene Corporation, melt flow rate (MFR): 0.5 g/10 min], 45 parts by weight of a mixture [melt flow rate (MFR): 6 g/10 min, JIS-A hardness: 79°] including a polyolefinic elastomer and a softener, 10 parts by weight of magnesium hydroxide, 10 parts by weight of carbon (trade name “Asahi #35,” Asahi Carbon Co., Ltd.), and 1.5 parts by weight of stearic monoglyceride. The kneadate was extruded into strands, cooled with water, and formed into pellets. The pellets were charged into a single-screw extruder (The Japan Steel Works, LTD.), into which carbon dioxide gas was injected at an ambient temperature of 220° C. and a pressure of 19 MPa, where the pressure became 16 MPa after injection. The carbon dioxide gas was injected in an amount of 5.9 percent by weight relative to the total amount of the pellets. After being sufficiently saturated with the carbon dioxide gas, the pellets were cooled to a temperature suitable for expansion, extruded through a ring die into a tubular foam, allowed to pass through between a mandrel for cooling the inner surface of the tubular foam extruded from the ring die and an air ring for cooling the outer surface of the tubular foam, cut in part of its diameter, unfolded to a sheet, wound, and yielded a raw long foam sheet. The raw long foam sheet had an average cell diameter in its cell structure of 75 μm and a thickness of 2.0 mm. The raw long foam sheet had skin layers on both sides.

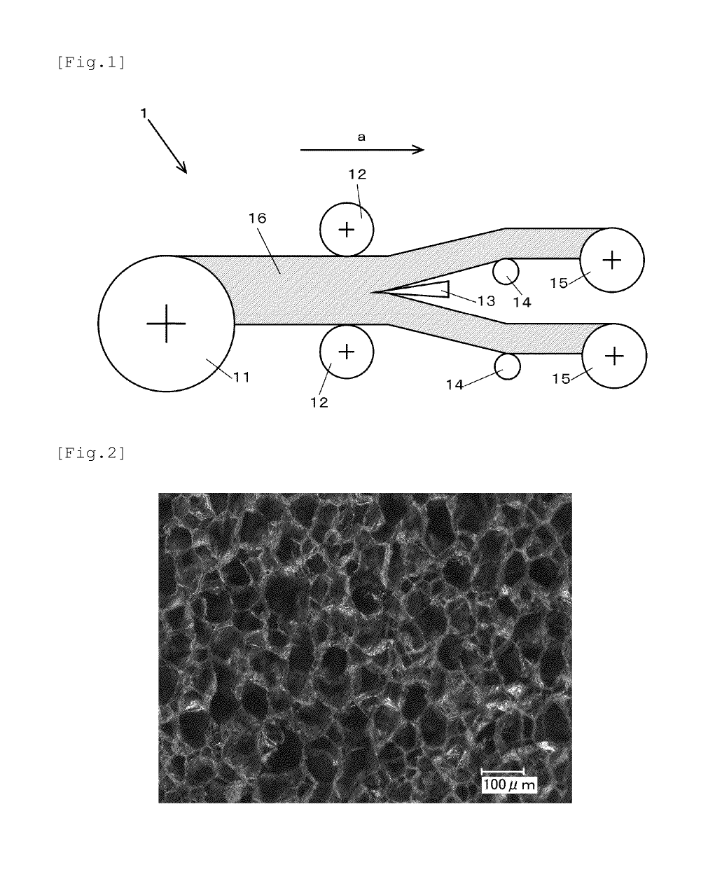

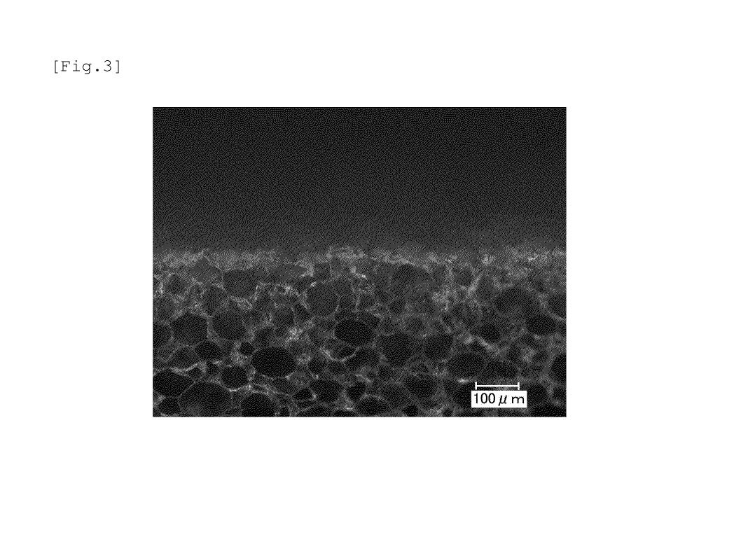

The raw long foam sheet was cut (slit) to a predetermined width, from which the surface skin layers were stripped one by one using a continuous slicing system (slicing line) as illustrated in FIG. 1. Specifically, the raw long foam sheet was allowed to pass through the continuous slicing system two times to remove the skin layers from both sides. The continuous slicing gave openings on both sides of the foam. The slitting and the continuous slicing did not cause widthwise contraction.

The article after the formation of openings was wound and yielded a long resin foam sheet. The continuous slicing of the long resin foam sheet had been performed at a target thickness (intended thickness) of 0.3 mm.

### Example 2

In a twin-screw kneader (The Japan Steel Works, LTD. (JSW)) at a temperature of 200° C. were kneaded 40 parts by weight of a polypropylene [trade name “EA9,” Japan Polypropylene Corporation, melt flow rate (MFR): 0.5 g/10 min], 55 parts by weight of a mixture [melt flow rate (MFR): 2 g/10 min, JIS-A hardness: 69°] including a dynamically-cross-linked polyolefinic elastomer and a softener, 10 parts by weight of magnesium hydroxide, 10 parts by weight of carbon (trade name “Asahi #35,” Asahi Carbon Co., Ltd.), and 0.8 part by weight of stearic monoglyceride. The kneadate was extruded into strands, cooled with water, and formed into pellets. The pellets were charged into a single-screw extruder (The Japan Steel Works, LTD.), into which carbon dioxide gas was injected at an ambient temperature of 220° C. and a pressure of 19 MPa, where the pressure became 16 MPa after injection. The carbon dioxide gas was injected in an amount of 4.8 percent by weight relative to the total amount of the pellets. After being sufficiently saturated with the carbon dioxide gas, the pellets were cooled to a temperature suitable for expansion, extruded through a ring die into a tubular foam, allowed to pass through between a mandrel for cooling the inner surface of the tubular foam extruded from the ring die and an air ring for cooling the outer surface of the tubular foam, cut in part of its diameter, unfolded to a sheet, wound, and yielded a raw long foam sheet. The raw long foam sheet had an average cell diameter in its cell structure of 90 μm and a thickness of 2.0 mm. The raw long foam sheet had skin layers on both sides.

The raw long foam sheet was cut (slit) to a predetermined width, from which the surface skin layers were stripped one by one using a continuous slicing system (slicing line) as illustrated in FIG. 1. Specifically, the raw long foam sheet was allowed to pass through the continuous slicing system two times to remove the skin layers from both sides. The continuous slicing gave openings on both sides of the foam. The slitting and the continuous slicing did not cause widthwise contraction.

The article after the formation of openings was wound and yielded a long resin foam sheet. The continuous slicing of the long resin foam sheet had been performed at a target thickness (intended thickness) of 0.5 mm.

### Example 3

In a twin-screw kneader (The Japan Steel Works, LTD. (JSW)) at a temperature of 200° C. were kneaded 40 parts by weight of a polypropylene [trade name “EA9,” Japan Polypropylene Corporation, melt flow rate (MFR): 0.5 g/10 min], 40 parts by weight of a mixture [melt flow rate (MFR): 2 g/10 min, JIS-A hardness: 69°] including a dynamically-cross-linked polyolefinic elastomer and a softener, 10 parts by weight of magnesium hydroxide, 10 parts by weight of carbon (trade name “Asahi #35,” Asahi Carbon Co., Ltd.), and 1.5 parts by weight of stearic monoglyceride. The kneadate was extruded into strands, cooled with water, and formed into pellets. The pellets were charged into a single-screw extruder (The Japan Steel Works, LTD.), into which carbon dioxide gas was injected at an ambient temperature of 220° C. and a pressure of 19 MPa, where the pressure became 16 MPa after injection. The carbon dioxide gas was injected in an amount of 4.6 percent by weight relative to the total amount of the pellets. After being sufficiently saturated with the carbon dioxide gas, the pellets were cooled to a temperature suitable for expansion, extruded through a ring die into a tubular foam, allowed to pass through between a mandrel for cooling the inner surface of the tubular foam extruded from the ring die and an air ring for cooling the outer surface of the tubular foam, cut in part of its diameter, unfolded to a sheet, wound, and yielded a raw long foam sheet. The raw long foam sheet had an average cell diameter in its cell structure of 130 μm and a thickness of 2.2 mm. The raw long foam sheet had skin layers on both sides.

The raw long foam sheet was cut (slit) to a predetermined width, from which the surface skin layers were stripped one by one using a continuous slicing system (slicing line) as illustrated in FIG. 1. Specifically, the raw long foam sheet was allowed to pass through the continuous slicing system two times to remove the skin layers from both sides. The continuous slicing gave openings on both sides of the foam. The slitting and the continuous slicing did not cause widthwise contraction.

The article after the formation of openings was wound and yielded a long resin foam sheet. The continuous slicing of the long resin foam sheet had been performed at a target thickness (intended thickness) of 0.5 mm.

### Example 4

In a twin-screw kneader (The Japan Steel Works, LTD. (JSW)) at a temperature of 200° C. were kneaded 45 parts by weight of a polypropylene [trade name “EA9,” Japan Polypropylene Corporation, melt flow rate (MFR): 0.5 g/10 min], 45 parts by weight of a mixture [melt flow rate (MFR): 6 g/10 min, JIS-A hardness: 79°] including a polyolefinic elastomer and a softener, 90 parts by weight of magnesium hydroxide, 10 parts by weight of carbon (trade name “Asahi #35,” Asahi Carbon Co., Ltd.), and 1.5 parts by weight of stearic monoglyceride. The kneadate was extruded into strands, cooled with water, and formed into pellets. The pellets were charged into a single-screw extruder (The Japan Steel Works, LTD.), into which carbon dioxide gas was injected at an ambient temperature of 220° C. and a pressure of 19 MPa, where the pressure became 16 MPa after injection. The carbon dioxide gas was injected in an amount of 2.5 percent by weight relative to the total amount of the pellets. After being sufficiently saturated with the carbon dioxide gas, the pellets were cooled to a temperature suitable for expansion, extruded through a ring die into a tubular foam, allowed to pass through between a mandrel for cooling the inner surface of the tubular foam extruded from the ring die and an air ring for cooling the outer surface of the tubular foam, cut in part of its diameter, unfolded to a sheet, wound, and yielded a raw long foam sheet. The raw long foam sheet had an average cell diameter in its cell structure of 50 μm and a thickness of 1.5 mm. The raw long foam sheet had skin layers on both sides.

The raw long foam sheet was cut (slit) to a predetermined width, from which the surface skin layers were stripped one by one using a continuous slicing system (slicing line) as illustrated in FIG. 1. Specifically, the raw long foam sheet was allowed to pass through the continuous slicing system two times to remove the skin layers from both sides. The continuous slicing gave openings on both sides of the foam. The slitting and the continuous slicing did not cause widthwise contraction.

The article after the formation of openings was wound and yielded a long resin foam sheet. The continuous slicing of the long resin foam sheet had been performed at a target thickness (intended thickness) of 0.3 mm.

### Example 5

In a twin-screw kneader (The Japan Steel Works, LTD. (JSW)) at a temperature of 200° C. were kneaded 65 parts by weight of a polypropylene [trade name “EA9,” Japan Polypropylene Corporation, melt flow rate (MFR): 0.5 g/10 min], 35 parts by weight of a polyolefinic elastomer [melt flow rate (MFR): 6 g/10 min, JIS-A hardness: 79°], 120 parts by weight of magnesium hydroxide, 10 parts by weight of carbon (trade name “Asahi #35,” Asahi Carbon Co., Ltd.), and 1.5 parts by weight of stearic monoglyceride. The kneadate was extruded into strands, cooled with water, and formed into pellets. The pellets were charged into a single-screw extruder (The Japan Steel Works, LTD.), into which carbon dioxide gas was injected at an ambient temperature of 220° C. and a pressure of 19 MPa, where the pressure became 16 MPa after injection. The carbon dioxide gas was injected in an amount of 3.0 percent by weight relative to the total amount of the pellets. After being sufficiently saturated with the carbon dioxide gas, the pellets were cooled to a temperature suitable for expansion, extruded through a ring die into a tubular foam, allowed to pass through between a mandrel for cooling the inner surface of the tubular foam extruded from the ring die and an air ring for cooling the outer surface of the tubular foam, cut in part of its diameter, unfolded to a sheet, wound, and yielded a raw long foam sheet. The raw long foam sheet had an average cell diameter in its cell structure of 88 μm and a thickness of 2.2 mm. The raw long foam sheet had skin layers on both sides.

The raw long foam sheet was cut (slit) to a predetermined width, from which the surface skin layers were stripped one by one using a continuous slicing system (slicing line) as illustrated in FIG. 1. Specifically, the raw long foam sheet was allowed to pass through the continuous slicing system two times to remove the skin layers from both sides. The continuous slicing gave openings on both sides of the foam. The slitting and the continuous slicing did not cause widthwise contraction.

The article after the formation of openings was wound and yielded a long resin foam sheet. The continuous slicing of the long resin foam sheet had been performed at a target thickness (intended thickness) of 0.4 mm.

### Comparative Example 1

An acrylic elastomer was prepared from 85 parts by weight of butyl acrylate, 15 parts by weight of acrylonitrile, and 6 parts by weight of acrylic acid. The acrylic elastomer had an acrylic acid content of 5.67 percent by weight and a weight-average molecular weight of 217×10⁴ (in terms of polystyrene standard). The acrylic elastomer was kneaded with 75 parts by weight of a trifunctional acrylate (trimethylolpropane trimethacrylate, trade name “NK Ester TMPT,” Shin-Nakamura Chemical Co., Ltd.) and 50 parts by weight of inorganic particles (magnesium hydroxide, trade name “EP1-A,” Konoshima Chemical Co., Ltd.) in a compact double-blade 10-L press kneader (Toshin Co., Ltd.) at a temperature of 60° C. for about 40 minutes and thereby yielded a resin composition.

The resin composition was kneaded in a single-screw extruder at an ambient temperature of 60° C. while high-pressure carbon dioxide (CO₂) was supplied in an amount of 3.6 percent by weight at a gas pressure of 19 MPa to the single-screw extruder to impregnate the resin composition sufficiently with carbon dioxide. Next, the impregnated resin composition was expanded by a molding/decompression step in which molding and expansion were simultaneously performed by extruding the resin composition through a ring die arranged at the tip of the single-screw extruder so as to release pressure to atmospheric pressure. The resulting foam was cut, unfolded to a sheet, and yielded a foam structure.

Next, electron beams at an acceleration voltage of 250 kV and an irradiation energy of 200 kGy were applied to both sides of the foam structure to react the trifunctional acrylate. Thus, a crosslinked structure was formed to fix a cell structure to thereby yield a sheet-like resin foam having an average cell diameter of 120 μm and a thickness of 2.1 mm. The resin foam had skin layers on both sides.

For yielding a resin foam sheet, the resin foam was subjected to stripping of surface skin layers one by one at a target thickness (intended thickness) of 0.3 mm using a continuous slicing system (slicing line) as illustrated in FIG. 1. However, the resin foam failed to give a long rolled resin foam sheet because breaking occurred during the slicing using the continuous slicing system.

The apparent density, tensile strength, and compression stress upon 50%-compression of this sample could be determined using the broken sheet piece.

### Example 6

In a twin-screw kneader (The Japan Steel Works, LTD. (JSW)) at a temperature of 200° C. were kneaded 45 parts by weight of a polypropylene [trade name “EA9,” Japan Polypropylene Corporation, melt flow rate (MFR): 0.5 g/10 min], 45 parts by weight of a polyolefinic elastomer [melt flow rate (MFR): 6 g/10 min, JIS-A hardness: 79°], 10 parts by weight of magnesium hydroxide, 10 parts by weight of carbon (trade name “Asahi #35,” Asahi Carbon Co., Ltd.), and 1.5 parts by weight of stearic monoglyceride. The kneadate was extruded into strands, cooled with water, and formed into pellets. The pellets were charged into a single-screw extruder (The Japan Steel Works, LTD.), into which carbon dioxide gas was injected at an ambient temperature of 220° C. and a pressure of 19 MPa, where the pressure became 16 MPa after injection. The carbon dioxide gas was injected in an amount of 5.9 percent by weight relative to the total amount of the pellets. After being sufficiently saturated with the carbon dioxide gas, the pellets were cooled to a temperature suitable for expansion, extruded through a ring die into a tubular foam, allowed to pass through between a mandrel for cooling the inner surface of the tubular foam extruded from the ring die and an air ring for cooling the outer surface of the tubular foam, cut in part of its diameter, unfolded to a sheet, wound, and yielded a raw long foam sheet. The raw long foam sheet had an average cell diameter in its cell structure of 75 μm and a thickness of 2.0 mm. The raw long foam sheet had skin layers on both sides. Upon extrusion from the die, gap control was intentionally performed with a machine bolt. The resulting raw long foam sheet thereby suffered from unevenness in thickness.

The raw long foam sheet was cut (slit) to a predetermined width, from which the surface skin layers were stripped one by one using a continuous slicing system (slicing line) as illustrated in FIG. 1. Specifically, the raw long foam sheet was allowed to pass through the continuous slicing system two times to remove the skin layers from both sides. The continuous slicing gave openings on both sides of the foam. The slitting and the continuous slicing did not cause widthwise contraction.

The article after the formation of openings was wound and yielded a long resin foam sheet. The continuous slicing of the long resin foam sheet had been performed at a target thickness (intended thickness) of 0.3 mm.

[Evaluations]

The examples and comparative example were examined by the following measurements and evaluations. The results are indicated in Table 1.

Apparent Density

Each resin foam sheet was punched with a punching die 40 mm wide and 40 mm long and yielded a measurement sample. An apparent density (g/cm³) of the measurement sample was determined according to JIS K 6767.

Specifically, a width and a length of the measurement sample were measured, and a thickness (mm) thereof was measured with a 1/100 scaled dial gauge having a measuring terminal 20 mm in diameter (φ). A volume (cm³) of the resin foam (sample) was determined from these data. Next, a weight (g) of the measurement sample was measured with an even balance having a minimum scale of 0.01 g or more. An apparent density (g/cm³) was calculated from the volume and the measured weight.

### Tensile Strength

A lengthwise tensile strength (MPa) of each resin foam sheet was measured according to the method prescribed in “Tensile Strength and Elongation” of JIS K 6767.

Thickness, Thickness Tolerance (Thickness Range), Median Thickness, and “Value Determined According to Expression (1)”)

Thicknesses of each resin foam sheet were measured at intervals of 10 mm on a measurement line passing through lengthwise one point and extending widthwise from one end to the other; thicknesses were further measured at intervals of 10 mm on another measurement line passing through another point 1 m lengthwise away from the lengthwise one point and extending widthwise from one end to the other; and an average, a maximum, and a minimum were determined from all the measured thicknesses.

The thickness measurement was performed with a 1/100-scaled dial gauge having a measuring terminal 20 mm in diameter (φ).

The average of the measured thicknesses was defined as a “thickness” (mm) of the sample resin foam sheet.

A difference between the maximum and the minimum was defined as a “thickness tolerance (thickness range)” (mm).

A median (a value in center) of the measured thicknesses arranged in increasing order was defined as a “median thickness” (mm).

A “value determined according to Expression (1)” (%) was calculated according to following Expression (1):

(Thickness tolerance)/(Median thickness)×100 (1)

Compression Stress upon 50%—Compression (Repulsion Stress upon 50%—Compression)

A stress (N) of each resin foam sheet was measured according to JIS K 6767 upon compression in a thickness direction by 50% of the initial thickness, and the measured stress was converted into a value per unit area (cm²), and the converted value was defined as a compression stress (N/cm²) upon 50%—compression.

Thickness Accuracy

A thickness accuracy of each resin sheet foam was determined according to following Expression (2).

In Expression (2), the “target value” refers to a thickness to be aimed (target thickness or intended thickness). Typically, the target thickness (intended thickness) was set to 0.3 mm in Example 1, in which two passes of continuous slicing were performed in order to obtain this thickness as a final thickness.

Thickness accuracy (%)=[(Thickness tolerance)/2]/(Target value)×100 (2)

Evaluation on Winding Stability

Whether a sample resin foam sheet suffered from tearing and/or breaking upon winding in its preparation and whether the wound roll suffered from wrinkling (winding wrinkle) were examined, and winding stability was evaluated according to the following criteria.

Criteria:

“Good”: The sample was free from tearing, breaking, and wrinkling

“Wrinkled”: The sample suffered from wrinkling

“Broken”: The sample suffered from tearing or breaking, or both.

TABLE 1

| | | | | | | Com. | Com. |
|---|---|---|---|---|---|---|---|
| | Example 1 | Example 2 | Example 3 | Example 4 | Example 5 | Ex. 1 | Ex. 2 |
| Thickness [mm] | 0.30 | 0.50 | 0.49 | 0.29 | 0.41 | — | 0.28 |
| Length [m] | 100 | 100 | 100 | 100 | 100 | — | 100 |
| Width [mm] | 500 | 500 | 500 | 500 | 300 | 500 | 500 |
| Apparent density [g/cm³] | 0.042 | 0.061 | 0.052 | 0.131 | 0.074 | 0.071 | 0.041 |
| Tensile strength [MPa] | 1.32 | 0.80 | 0.70 | 0.90 | 0.61 | 0.19 | 1.34 |
| Compression stress | 1.50 | 1.62 | 1.72 | 3.20 | 3.91 | 2.04 | 1.48 |
| upon 50%-compression | | | | | | | |
| [N/cm²] | | | | | | | |
| Thickness tolerance [mm] | 0.07 | 0.09 | 0.08 | 0.06 | 0.04 | — | 0.09 |
| Median thickness [mm] | 0.31 | 0.52 | 0.52 | 0.28 | 0.41 | — | 0.29 |
| Value determined by | 22.6 | 17.3 | 15.4 | 21.4 | 9.7 | — | 31.6 |
| Expression (1) [%] | | | | | | | |
| Target thickness [mm] | 0.3 | 0.5 | 0.5 | 0.3 | 0.4 | — | 0.3 |
| Thickness accuracy [%] | 11.7 | 9.0 | 8.0 | 10.0 | 10.0 | — | 15.0 |
| Average cell diameter [μm] | 75 | 90 | 130 | 50 | 88 | 120 | 72 |
| Winding stability | Good | Good | Good | Good | Good | Broken | Wrinkled |

### INDUSTRIAL APPLICABILITY

Resin foam sheets and resin foam members according to embodiments of the present invention are usable typically as dust proofers, sealants (foamed sealants), acoustic insulators, and cushioning materials for use in assembling (mounting) of a member or part of every kind to a predetermined position.

Reference Signs List
1 continuous slicing system (slicing line)
11 feed roll
12 pinch roll
13 cutting blade (slicing blade)
14 control roll
15 winding roll
16 resin foam

While preferred embodiments of the present invention have been described using specific terms, such description is for illustrated purposes only, and it is to be understood that various changes and modifications may be made without departing from the spirit and scope of the present invention as defined in the appended claims.

1. A resin foam sheet having an apparent density of 0.02 to 0.30 g/cm³, a tensile strength of 0.5 to 3.0 MPa, a thickness of 0.20 to 0.70 mm, a length of 5 m or more, and a width of 300 mm or more and having openings on both sides thereof.

2. The resin foam sheet of claim 1, wherein the resin foam sheet has a value of 30% or less, the value determined according to following Expression (1):
(Thickness tolerance)/(Median thickness)×100 (1)
wherein the thickness tolerance is determined by measuring thicknesses at intervals of 10 mm on a measurement line passing through lengthwise one point and extending widthwise from one end to the other, further measuring thicknesses at intervals of 10 mm on another measurement line passing through another point 1 m lengthwise away from the lengthwise one point and extending widthwise from one end to the other, and defining a difference between a maximum and a minimum among all the measured thicknesses as the thickness tolerance; and
the median thickness is defined as a value in the center of all the measured thicknesses arranged in increasing order.

3. The resin foam sheet of claim 1, wherein the openings have been formed by slicing.

4. The resin foam sheet of claim 1, wherein the resin foam sheet has been formed by foaming a resin composition.

5. The resin foam sheet of claim 4, wherein the resin composition has been foamed with a supercritical fluid.

6. A resin foam member comprising:
the resin foam sheet of claim 1; and
a pressure-sensitive adhesive layer present on at least one side of the resin foam sheet.
